(19) United States
(12) Patent Application Publication
(10) Pub. No.: US 2013/0151586 A1
(43) Pub. Date: Jun. 13, 2013

(54) MESSAGE DISTRIBUTION SERVER, SIP SERVER, AND MESSAGE DISTRIBUTION METHOD

(71) Applicant: Fujitsu Limited, Kawasaki-shi (JP)

(72) Inventors: Yoshihito Morishige, Kawasaki (JP); Hiroyasu Bandou, Kawasaki (JP); Takashi Mitsuhashi, Naka (JP); Yuji Tajima, Yokohama (JP)

(73) Assignee: FUJITSU LIMITED, Kawasaki-shi (JP)

(21) Appl. No.: 13/661,528

(22) Filed: Oct. 26, 2012

(30) Foreign Application Priority Data
Dec. 12, 2011 (JP) 2011-271064

(51) Int. Cl. G06F 15/16

(52) U.S. Cl. 709/203

(57) ABSTRACT

A message distribution server includes a processor. The processor is configured to receive a first SIP (Session Initiation Protocol) message from an SIP client, obtain an identifier of an SIP server from a header of the first SIP message, identify an SIP server corresponding to the obtained identifier from among a plurality of SIP servers each configured to control a session for the SIP client, and distribute the first SIP message to the identified SIP server.

### CROSS-REFERENCE TO RELATED APPLICATION

This application is based upon and claims the benefit of priority of the prior Japanese Patent Application No. 2011-271064, filed on Dec. 12, 2011, the entire contents of which are incorporated herein by reference.

### FIELD

The embodiments discussed herein are related to a message distribution server.

### BACKGROUND

An SIP (Session Initiation Protocol) message distribution apparatus configured to distribute an SIP message is proposed. The SIP message distribution apparatus extracts session information from an SIP message. Session information is information related to a session to which this SIP message belongs. Then, the SIP message distribution apparatus performs a hashing operation by using the extracted session information to calculate a hash value. Subsequently, the SIP message distribution apparatus determines a distribution destination of the SIP message in accordance with the calculated hash value.

Japanese Laid-open Patent Publication No. 2010-3273 discloses a related technique.

A proxy server configured to distribute SIP messages to plural SIP server apparatuses is required to distribute SIP messages in a same session to a same SIP server apparatus.

### SUMMARY

According to an aspect of the present invention, provided is a message distribution server including a processor. The processor is configured to receive a first SIP (Session Initiation Protocol) message from an SIP client, obtain an identifier of an SIP server from a header of the first SIP message, identify an SIP server corresponding to the obtained identifier from among a plurality of SIP servers each configured to control a session for the SIP client, and distribute the first SIP message to the identified SIP server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an entire configuration of a communication system;

FIG. 2 illustrates an example of a hardware configuration of a distribution server apparatus;

FIG. 3 illustrates an example of a functional configuration of a distribution server apparatus;

FIG. 4 is a flowchart illustrating an example of hashing operation processing;

FIG. 5 illustrates an example of a distribution management table;

FIG. 6 illustrates an example of a hardware configuration of an SIP server apparatus;

FIG. 7 illustrates an example of a functional configuration of an SIP server apparatus;

FIG. 8 is a flowchart illustrating an example of table management processing;

FIG. 9 is a flowchart illustrating an example of processing upon reception of an INVITE message;

FIG. 10 is a flowchart illustrating an example of processing upon reception of an ACK message;

FIG. 11 is a sequence diagram illustrating a first example of processing performed when a server number is changed;

FIGS. 12A to 12C illustrate examples of a distribution management table;

FIG. 13 is a sequence diagram illustrating a second example of processing performed when a server number is changed;

FIG. 14 illustrates an example of a distribution management table;

FIG. 15 is a sequence diagram illustrating a third example of processing performed when a server number is changed;

FIG. 16 is a flowchart illustrating an example of distribution processing for a subsequent message; and

FIG. 17 is a sequence diagram illustrating an example of processing performed upon reception of a subsequent message.

### DESCRIPTION OF EMBODIMENTS

1. Exemplary System Configuration

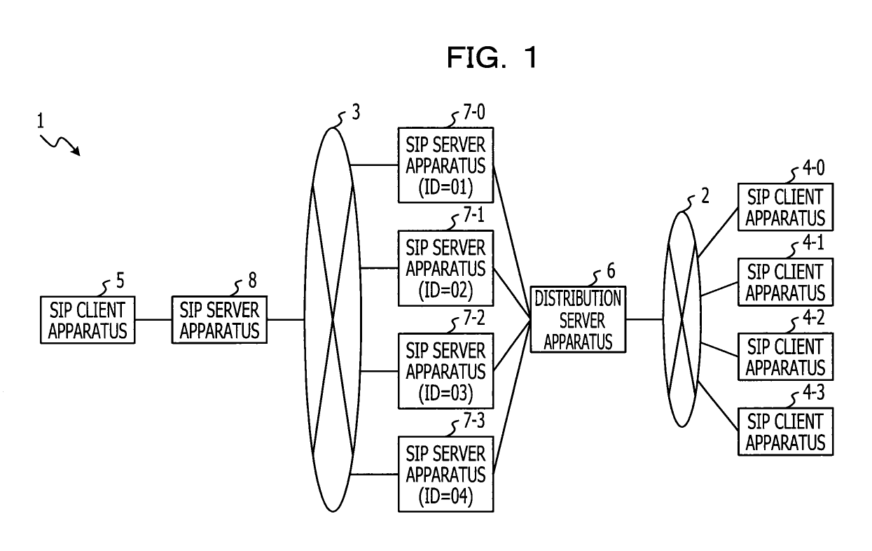

Hereinafter, embodiments will be described with reference to the accompanying drawings. FIG. 1 illustrates an example of an entire configuration of a communication system. A communication system 1 includes Internet protocol (IP) networks 2 and 3, SIP client apparatuses 4-0 to 4-3 and 5, a distribution server apparatus 6, and SIP server apparatuses 7-0 to 7-3 and 8. The SIP client apparatuses 4-0 to 4-3 and 5 perform a communication via the IP network 3 by using the SIP. The SIP client apparatuses 4-0 to 4-3 are connected to the SIP server apparatuses 7-0 to 7-3 via the IP network 2 and the distribution server apparatus 6. In the following description, the SIP client apparatuses 4-0 to 4-3 and the SIP server apparatuses 7-0 to 7-3 may be collectively referred to as “SIP client apparatus 4” and “SIP server apparatus 7”, respectively. In addition, the SIP client apparatus, the distribution server apparatus, and the SIP server apparatus may be referred to as “SIP client”, “distribution server”, and “SIP server”, respectively.

The distribution server 6 operates as a stateless proxy server that does not manage the session information of an SIP session for the SIP client 4 or call statuses. The distribution server 6 terminates a protocol for receiving SIP messages from the SIP client 4 and distributes the SIP messages to the plural SIP servers 7. Also, the distribution server 6 terminates a protocol for receiving SIP messages from the SIP server 7 and transfers the SIP messages to the SIP client 4. The SIP servers 7 and 8 manage the session information of SIP sessions for the SIP clients 4 and 5, respectively, control SIP transactions, and generates response signals in response to received SIP requests. According to an embodiment, the distribution server 6 and the SIP server 7 may be installed in a same casing.

2. Distribution Server Apparatus

2.1. Exemplary Hardware Configuration

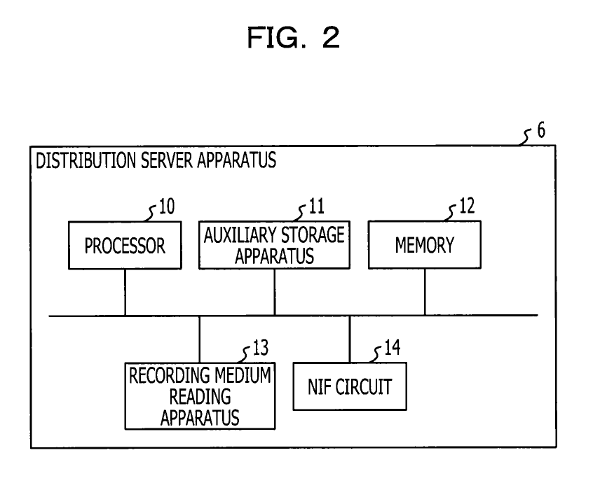

Subsequently, a description will be given of a configuration of the distribution server 6. FIG. 2 illustrates an example of a hardware configuration of the distribution server 6. The distribution server 6 includes a processor 10, an auxiliary storage apparatus 11, a memory 12, a recording medium reading apparatus 13, and a network interface circuit 14. It is noted that in the accompanying drawings, the network interface may be referred to as “NIF”. The hardware configuration illustrated in FIG. 2 is merely an exemplification of the hardware configuration for realizing the distribution server 6. Any other hardware configurations may also be adopted so long as processing which will be described below is executed.

The processor 10 performs an operation control on the distribution server 6 and distribution processing for the SIP messages which will be described below. The auxiliary storage apparatus 11 stores a computer program for causing the processor 10 to execute the processing. The auxiliary storage apparatus 11 includes a non-volatile storage device that stores the computer program. The non-volatile storage device may be, for example, a read-only memory (ROM), a flash memory, or a hard disk. The memory 12 stores various pieces of data and temporary data used when the processor 10 executes the computer program. The memory 12 may include a random access memory (RAM).

The recording medium reading apparatus 13 reads data stored in a computer-readable portable recording medium. The recording medium reading apparatus 13 may be, for example, a CD (Compact Disc)-ROM drive apparatus, a DVD (Digital Versatile Disk)-ROM drive apparatus, a flexible disk drive apparatus, or a CD-R (Compact Disc Recordable) drive apparatus. The recording medium reading apparatus 13 may also be a DVD-R (Digital Versatile Disk Recordable) drive apparatus, an MO (Magneto-Optical disk) drive apparatus, or an access apparatus to a flash memory apparatus. According to an embodiment, the computer program for causing the processor 10 to execute the distribution processing for the SIP messages, which will be described below, may be distributed while being stored in a computer-readable portable recording medium. The computer program is read by the recording medium reading apparatus 13 from the portable recording medium and installed into the auxiliary storage apparatus 11. The network interface circuit 14 is a communication interface circuit for transmitting and receiving SIP signals between the distribution server 6 and the SIP client 4 and between the distribution server 6 and the SIP server 7.

2.2. Exemplary Functional Configuration

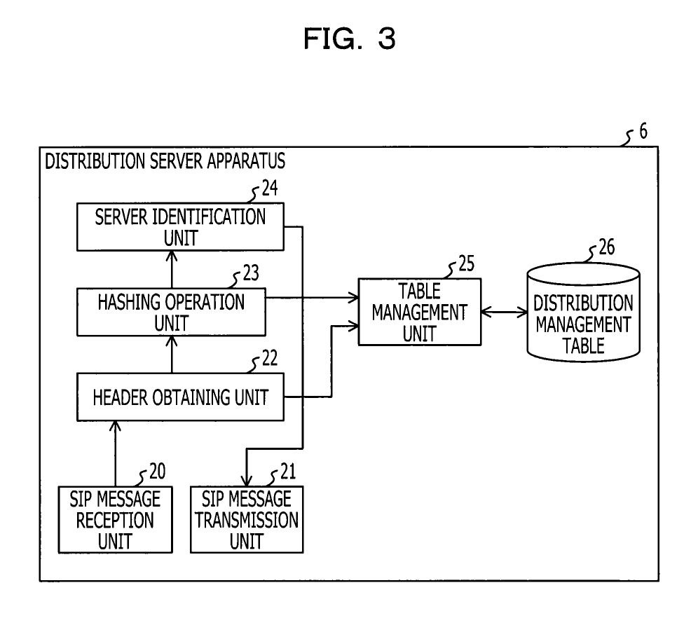

Subsequently, functions of the distribution server 6 realized by the above-mentioned hardware configuration will be described. FIG. 3 illustrates an example of a functional configuration of the distribution server 6. It is noted that FIG. 3 mainly illustrates functions related to the following description. The distribution server 6 may also include functional components other than the illustrated functional components.

The distribution server 6 includes an SIP message reception unit 20, an SIP message transmission unit 21, a header obtaining unit 22, a hashing operation unit 23, a server identification unit 24, and a table management unit 25. The operations of the SIP message reception unit 20 and the SIP message transmission unit 21, which will be described below, are performed by the network interface circuit 14 illustrated in FIG. 2. The operations of the header obtaining unit 22, the hashing operation unit 23, the server identification unit 24, and the table management unit 25, which will be described below, are performed by the processor 10. A distribution management table 26 is stored in the memory 12. According to another embodiment, the distribution management table 26 may be stored in a recordable auxiliary storage apparatus 11.

The SIP message reception unit 20 receives an SIP message from the SIP client 4 or the SIP server 7. The SIP message reception unit 20 performs a validity check on the received SIP message and performs decode processing to convert the SIP message into a format suitable to processing performed within the distribution server 6. The SIP message transmission unit 21 transmits an SIP message received from the SIP client 4 to the SIP server 7 specified by the server identification unit 24. In addition, the SIP message transmission unit 21 transmits an SIP message received from the SIP server 7 to the SIP client 4.

On the basis of the information received from the SIP message reception unit 20, the header obtaining unit 22 obtains a signal type of the received SIP message and SIP session information which is information described in a To header, a From header, and a Call-ID header of the SIP message. The To header is an action addressee specification header field in which an identifier of an action addressee of a request message is described. The From header is a generation origin specification header field in which an identifier of a generation origin of the request message is described. In addition, an identifier of SIP requests and responses generated in a continuous session is described in the Call-ID header. In the following description, the identifier specified by the Call-ID header of the SIP message may simply be referred to as “Call-ID”.

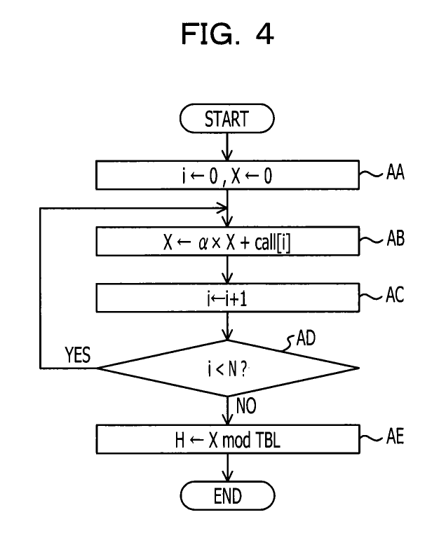

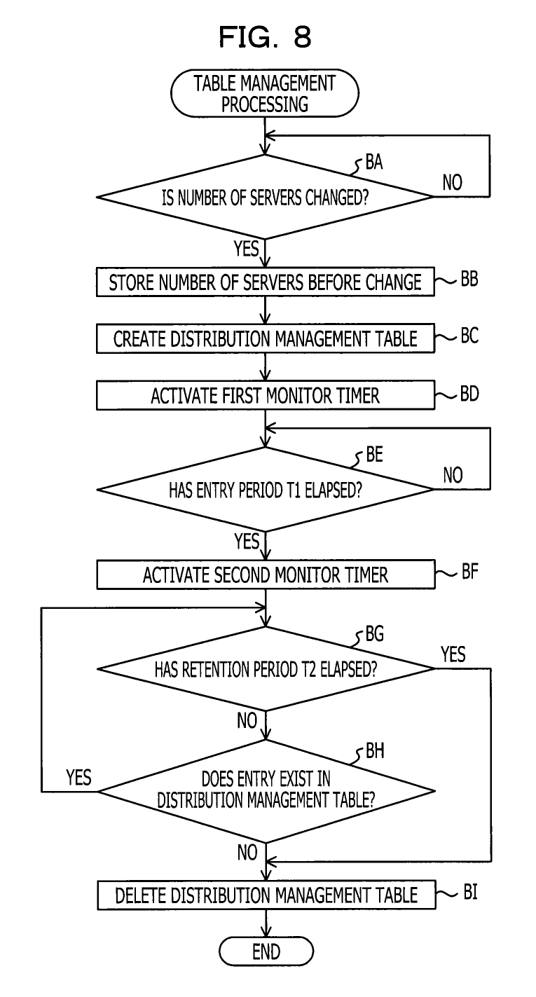

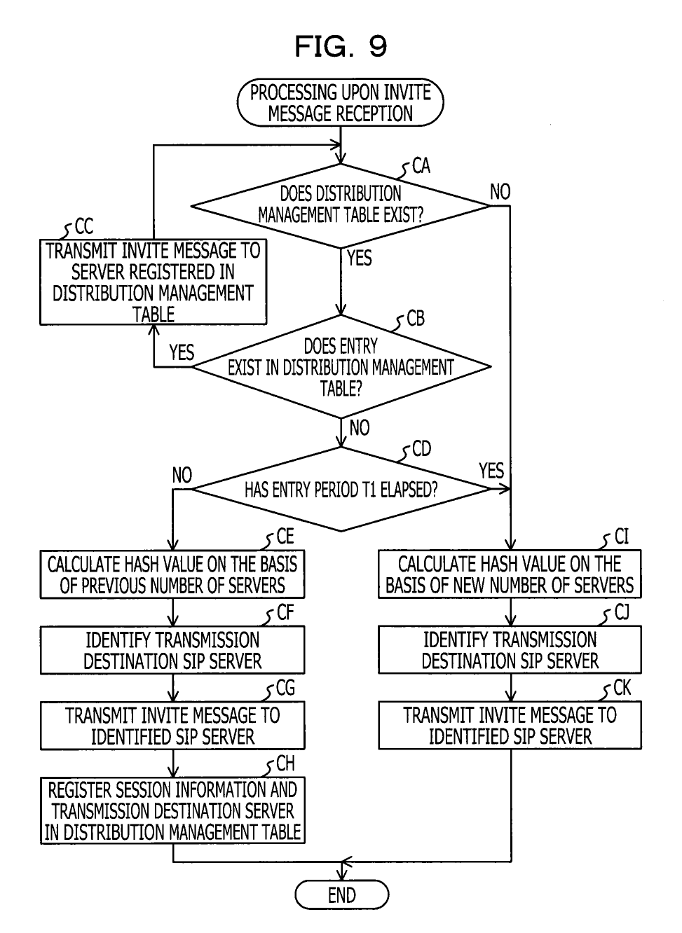

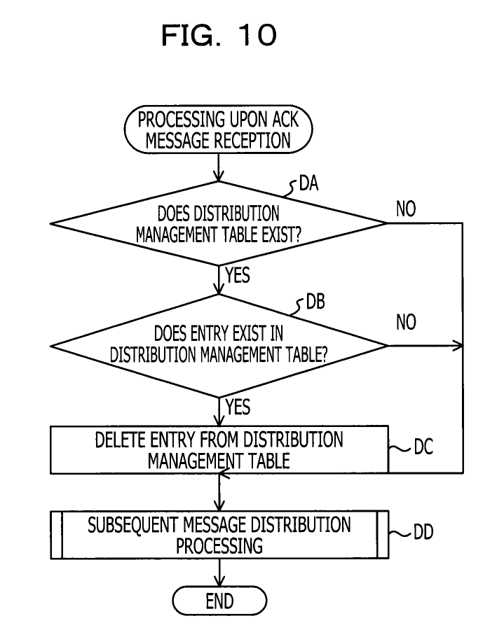

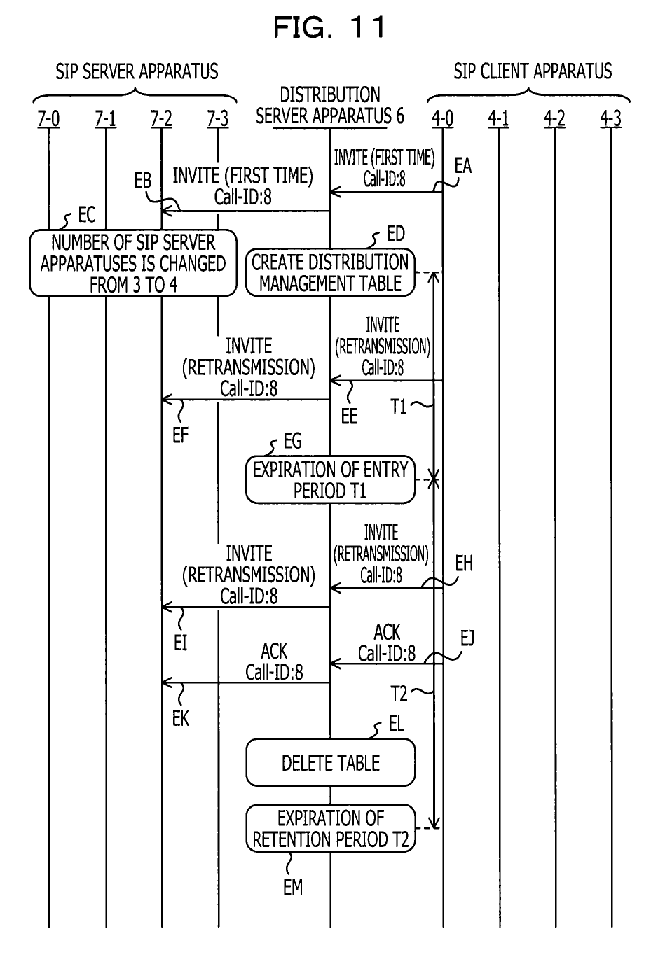

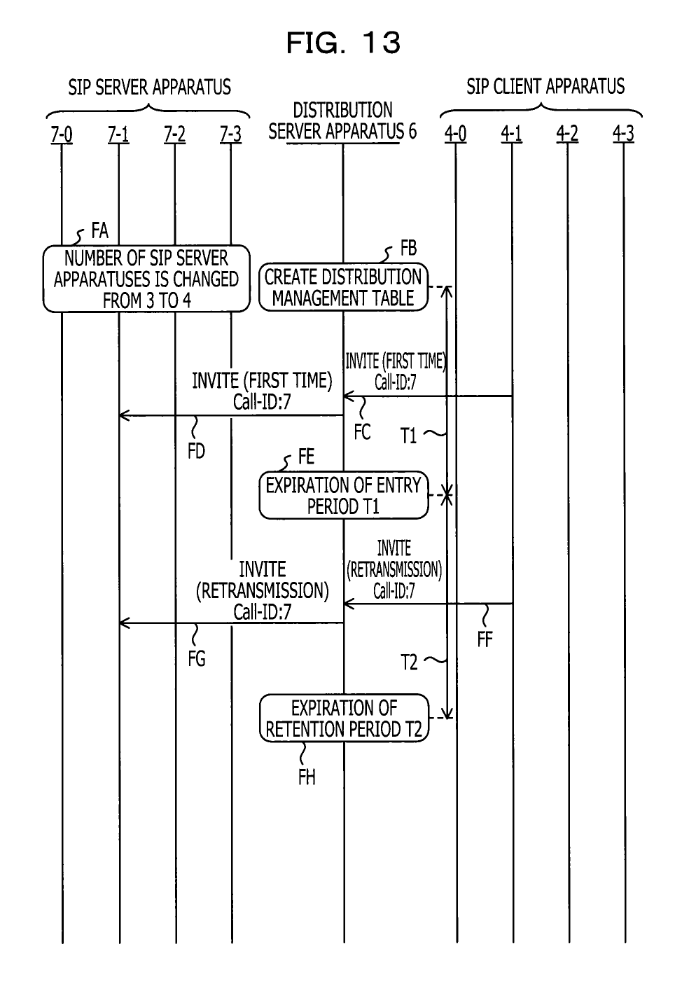

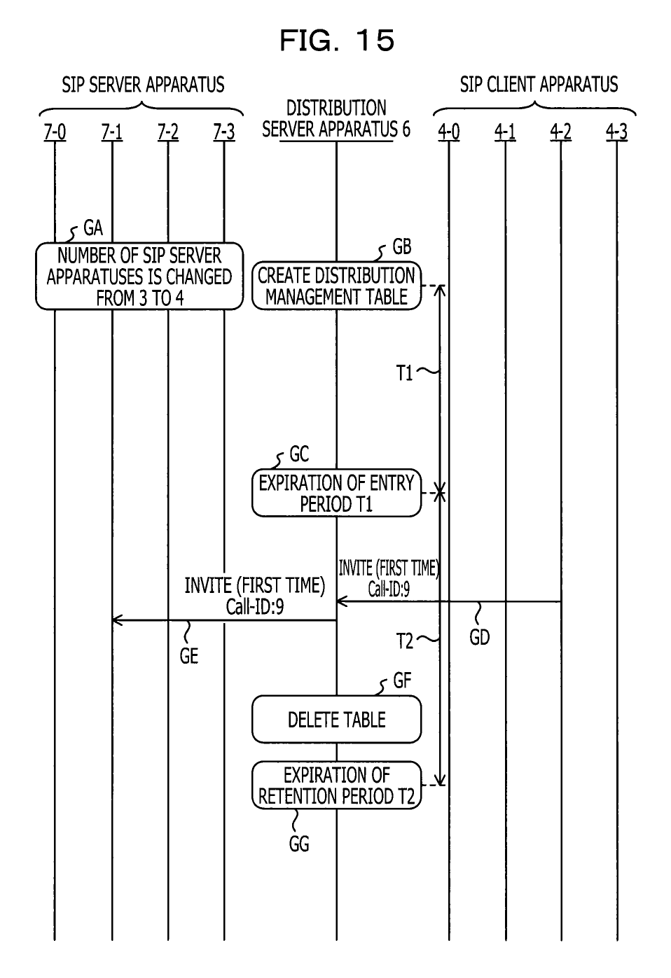

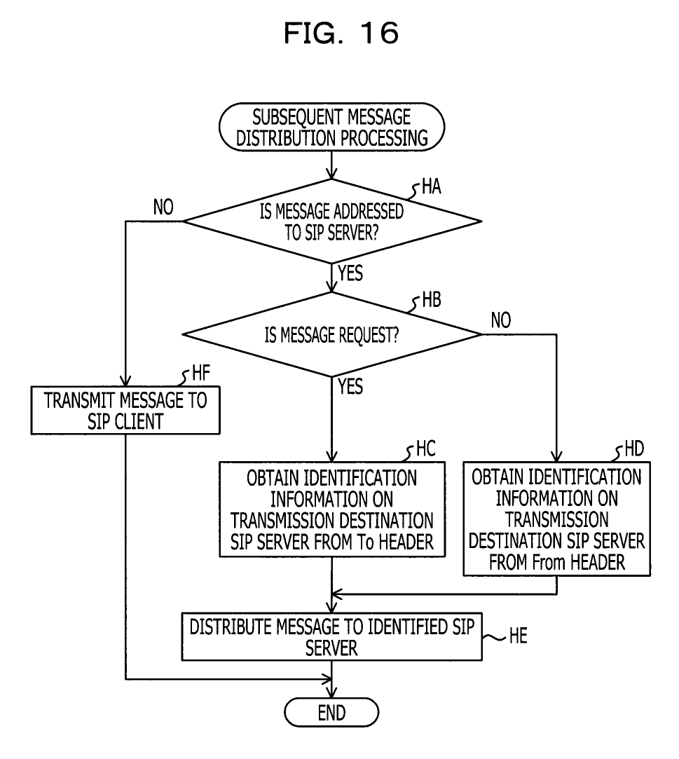

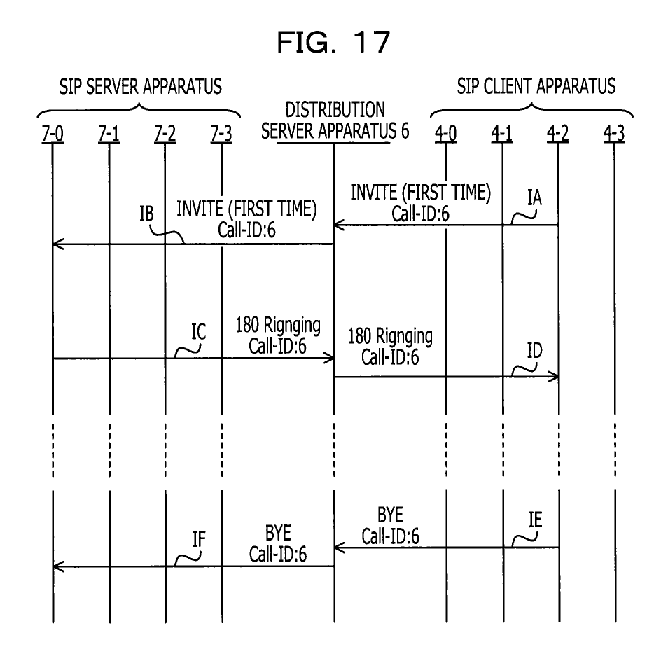

The hashing operation unit 23 performs a hashing operation by using the Call-ID obtained by the header obtaining unit 22. FIG. 4 is a flowchart illustrating an example of hashing operation processing. It is noted that hereinafter, a series of operations described with reference to FIG. 4 may be construed as a method including plural operations. The same applies to cases of FIG. 8, FIG. 9, FIG. 10, FIG. 11, FIG. 13, FIG. 15, FIG. 16, and FIG. 17.

Now, a case is assumed in which the Call-ID is a character string composed of N characters, and a character code at the (i+1)-th character is stored in an array variable “call”. A variable i is an index variable for specifying the respective characters call[i] of the array variable call. α is set as a predetermined factor. For example, a value of α may be “31”. A fixed number TBL is the number (referred to as “server number”) of the SIP servers 7 to which the SIP messages are distributed.

In AA, the hashing operation unit 23 initializes both values of variables i and X as “0”.

In AB, the hashing operation unit 23 substitutes a value of α×X+call[i] for the variable X.

In AC, the hashing operation unit 23 increase the value of the variable i by 1.

In AD, the hashing operation unit 23 determines whether or not the value of the variable i is lower than the number N of characters. In a case where the value of the variable i is lower than the number N of characters (AD: YES), the processing returns to AB. In a case where the value of the variable i is not lower than the number N of characters (AD: NO), the processing advances to AE.

In AE, the hashing operation unit 23 calculates a remainder (X mod TBL) by dividing the value of the variable X by a modulus TBL as a hash value H.

For sake of simplicity, in the following description, an embodiment will be described by way of an example in which the Call-ID is an integer value instead of a character string. For example, the Call-ID identifies the sessions on the basis of integer values such as “6”, “7”, “8”, and “9”.

The table management unit 25 performs a creation and a deletion of the distribution management table 26 and a registration, a deletion, and search processing on an entry of the distribution management table 26. The distribution management table 26 is a table used, in a case where the number of the SIP servers 7 to which the distribution server 6 distributes the SIP messages is changed, for temporarily storing information regarding the SIP servers 7 to which the SIP messages of the session, which continues before the change in the server number, to be distributed.

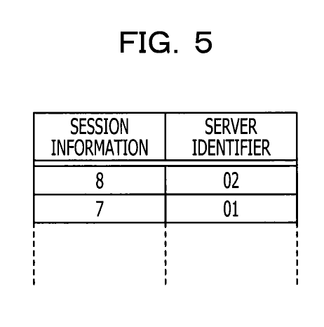

FIG. 5 illustrates an example of the distribution management table 26. The distribution management table 26 includes information elements “session information” and “server identifier”. The information element “session information” indicates a Call-ID of the session for the SIP message. The information element “server identifier” indicates an identifier of the SIP server 7 to which the distribution server 6 distributes the SIP message. For example, it is indicated in the example illustrated in FIG. 5 that an SIP message having the Call-ID=“8” is distributed to the SIP server 7 having the identifier “02”, and an SIP message having the Call-ID=“7” is distributed to the SIP server 7 having the identifier “01”.

The table management unit 25 creates the distribution management table 26 in a case where the number of the SIP servers 7 is changed. The table management unit 25 performs the registration of an entry to the distribution management table 26 only during a period of time having a predetermined length T1 after the generation of the distribution management table 26. In the following description, the period of time in which the table management unit 25 performs the registration of an entry to the distribution management table 26 is referred to as “entry period T1”.

During the entry period T1, in a case where the distribution server 6 receives an INVITE message corresponding to a session establishment request from the SIP client 4, the table management unit 25 registers an entry including the Call-ID of this message in the distribution management table 26. At the time of the registration of the entry, the table management unit 25 determines the identifier of the SIP server 7, which is set in the information element “server identifier”, according to the hash value calculated on the basis of the number of the SIP servers 7 before the change in the server number. Also, the table management unit 25 obtains, as the identifier of the SIP server 7 to which the INVITE message is distributed, the identifier of the SIP server 7 determined according to the hash value calculated on the basis of the number of the SIP servers 7 before the change in the server number.

The entry period T1 may be a period of time longer than, for example, a maximum retransmission interval for the SIP client 4 to retransmit the INVITE message in a case where a response to the INVITE message is not received. By determining the entry period T1 in the above-mentioned manner, even when the retransmission of the INVITE message transmitted immediately before the entry period T1 occurs, it is possible to register the entry of the retransmitted INVITE message. For example, in a case where the maximum retransmission interval of the INVITE message is 32 seconds, the entry period T1 may be 40 seconds.

The table management unit 25 deletes the distribution management table 26 after an elapse of a period of time of a predetermined length T2 after the elapse of the entry period T1. In the following description, the period of time after the elapse of the entry period T1 until the distribution management table 26 is deleted is referred to as “retention period T2”. In a case where the distribution server 6 receives an ACK message from the SIP client 4 before the elapse of the retention period T2, the table management unit 25 searches the distribution management table 26 for the entry including the Call-ID of this message.

The ACK message is an acknowledge response message as a final response to the INVITE message. In a case where the entry including the Call-ID of the ACK message exists in the distribution management table 26, the table management unit 25 deletes the entry. In a case where the distribution management table 26 becomes empty after the elapse of the entry period T1 before the elapse of the retention period T2, the table management unit 25 deletes the distribution management table 26.

In a case where the distribution server 6 receives the INVITE message from the SIP client 4 while the distribution management table 26 exists, the table management unit 25 searches the distribution management table 26 for the entry including the Call-ID of this message. In a case where the entry exists in the distribution management table 26, the table management unit 25 obtains a value of the information element “server identifier” of the entry as the identifier of the SIP server 7 to which the INVITE message is distributed.

The retention period T2 may be a period of time longer than the maximum retransmission interval of the INVITE message. By determining the retention period T2 in the above-mentioned manner, even when the retransmission of the first INVITE message transmitted immediately before the expiration of the entry period T1 occurs, the identifier of the SIP server 7 as the previous transmission destination is retained until the retransmission of the INVITE message. For example, in a case where the maximum retransmission interval of the INVITE message is 32 seconds, the retention period T2 may be 40 seconds. The table management unit 25 performs a timer control for managing the entry period T1 for the distribution management table and the retention period T2.

The server identification unit 24 identifies the SIP server 7 to which the INVITE message received in the entry period T1 is distributed on the basis of the identifier of the SIP server 7, which is obtained by the table management unit 25. In a case where the entry including the Call-ID of the INVITE message received in the retention period T2 exists in the distribution management table 26, the server identification unit 24 identifies the distribution destination of the INVITE message on the basis of the identifier of the SIP server 7 obtained by the table management unit 25.

The server identification unit 24 identifies the SIP server 7 to which the INVITE message received after the elapse of the retention period T2 is distributed by using the hash value H that is calculated by the hashing operation unit 23 on the basis of the number of the SIP servers 7 after the change in the server number. The same applies in a case where the entry including the Call-ID of the INVITE message received in the retention period T2 does not exist in the distribution management table 26 or after the distribution management table 26 is deleted in the retention period T2.

In a case where the distribution server 6 receives from the SIP client 4 a message generated after the first response to the INVITE message, the server identification unit 24 obtains the identification information of the SIP server 7 from a header of this message. In the following description, the message generated after the first response to the INVITE message is referred to as “subsequent message”. The first response to the INVITE message may be, for example, a 180 Ringing message, a 181 Call is Being Forward message, a 182 Queued message, or a 183 Session Progress message.

The server identification unit 24 identifies the SIP server 7 to which this subsequent message is distributed on the basis of the identification information of the SIP server 7 obtained from the header of the subsequent message. The header used by the server identification unit 24 to obtain the identification information of the SIP server 7 will be described in “3.2. Exemplary Functional configuration” of “3. SIP server apparatus” below.

The server identification unit 24 determines an IP address and port information corresponding to the identified SIP server 7 and transmits the SIP message via the SIP message transmission unit 21 to the identified SIP server 7.

3. SIP server apparatus

3.1. Exemplary Hardware Configuration

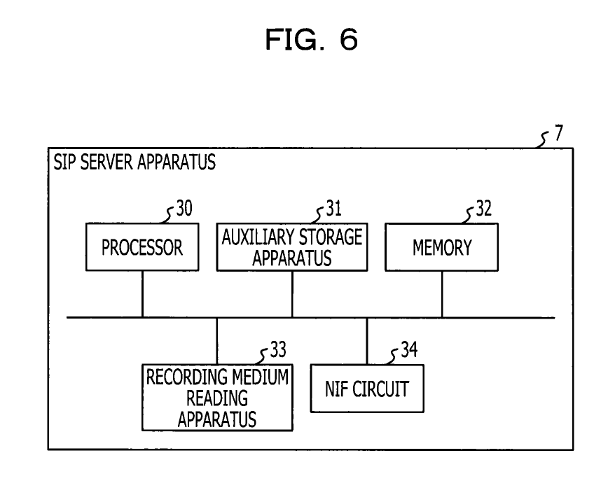

Subsequently, a description will be given of a configuration of the SIP server 7. FIG. 6 illustrates an example of a hardware configuration of the SIP server 7. The SIP server 7 includes a processor 30, an auxiliary storage apparatus 31, a memory 32, a recording medium reading apparatus 33, and a network interface circuit 34. It is noted that the hardware configuration illustrated in FIG. 6 is merely an exemplification of the hardware configuration for realizing the SIP server 7. Any other hardware configurations may also be adopted so long as processing which will be described below is executed.

The processor 30 performs an operation control on the SIP server 7, information management for SIP sessions, an SIP transaction control, a creation of a response message to an SIP request, and header change processing on the SIP message which will be described below. The auxiliary storage apparatus 31 stores a computer program for causing the processor 30 to execute the processing. The auxiliary storage apparatus 31 includes a non-volatile storage device that stores the computer program. The non-volatile storage device may be, for example, a read-only memory, a flash memory, or a hard disk. The memory 32 stores various pieces of data and temporary data used when the processor 30 executes the computer program. The memory 32 may include a random access memory.

The recording medium reading apparatus 33 reads data stored in a computer-readable portable recording medium. The recording medium reading apparatus 33 may be, for example, a CD-ROM drive apparatus, a DVD-ROM drive apparatus, a flexible disk drive apparatus, a CD-R drive apparatus, or a DVD-R drive apparatus, an MO drive apparatus, or an access apparatus to a flash memory apparatus. According to an embodiment, the computer program for causing the processor 30 to execute the header change processing on the SIP message, which will be described below, may be distributed while being stored in a computer-readable portable recording medium. The computer program is read by the recording medium reading apparatus 33 from the portable recording medium and installed into the auxiliary storage apparatus 31. The network interface circuit 34 is a communication interface circuit for transmitting and receiving the SIP signals between the SIP server 7 and the distribution server 6 and between the SIP server 7 and the IP network 3.

3.2. Exemplary Functional Configuration

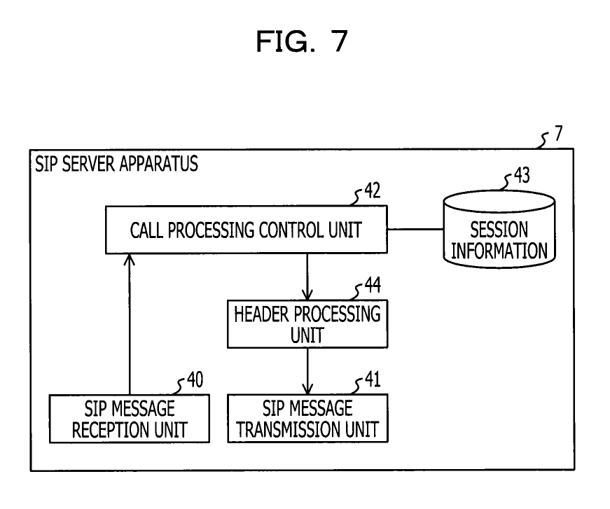

Subsequently, functions of the SIP server 7 realized by the above-mentioned hardware configuration will be described. FIG. 7 illustrates an example of a functional configuration of the SIP server 7. It is noted that FIG. 7 mainly illustrates functions related to the following description. The SIP server 7 may also include functional components other than the illustrated functional components.

The SIP server 7 includes an SIP message reception unit 40, an SIP message transmission unit 41, a call processing control unit 42, and a header processing unit 44. The operations of the SIP message reception unit 40 and the SIP message transmission unit 41, which will be described below, are performed by the network interface circuit 34 illustrated in FIG. 6. The operations of the call processing control unit 42 and the header processing unit 44, which will be described below, are performed by the processor 30. Session information 43 is stored in the memory 32. According to another embodiment, the session information 43 may be stored in a recordable auxiliary storage apparatus 31.

The SIP message reception unit 40 receives an SIP message from the distribution server 6 or the IP network 3. The SIP message reception unit 40 performs a validity check on the received SIP message and performs decode processing to convert the SIP message into a format suitable to processing performed within the SIP server 7. In response to an instruction from the call processing control unit 42, the SIP message transmission unit 41 transmits an SIP message received from the distribution server 6 to the IP network 3. In addition, in response to the instruction from the call processing control unit 42, the SIP message transmission unit 41 transmits an SIP message received from the IP network 3 to the SIP client 4 via the distribution server 6.

The call processing control unit 42 performs a management on the session information of the SIP session for the SIP client 4 and a control on an SIP transaction and generates a response signal to a received SIP request.

In a case where the SIP server 7 transmits, to the distribution server 6, an SIP message transferred to the SIP client 4, the header processing unit 44 adds the identification information of the SIP server 7 to a tag in a header field of this SIP message. The header added with the identification information of the SIP server 7 is a header to be reassigned by the SIP client 4 that has received this SIP message to a message transmitted from this SIP client 4 during the session in which this SIP message is transmitted.

For example, in a case where the SIP server 7 transmits, to the distribution server 6, an SIP request transferred to the SIP client 4, the header processing unit 44 may add the identification information of the SIP server 7 to a tag in the From header field of the SIP request. When transmitting an SIP message following the SIP request, the SIP client 4 reassigns the tag in the From header field of the SIP request to the From header field of the transmitted message.

Also, for example, in a case where the SIP server 7 transmits, to the distribution server 6, an SIP response transferred to the SIP client 4, the header processing unit 44 may add the identification information of the SIP server 7 to a tag in the To header field of the SIP response. When transmitting an SIP message following the SIP response, the SIP client 4 reassigns the tag in the To header field of the SIP response to the To header field of the transmitted message.

In addition, the header of the SIP message may be extended so as to include the header reassigned by the SIP client 4 in a similar matter that a reception client of a PUBLISH (Initial) response reassigns SIP-ETag header information to an SIP-If-Match header of a PUBLISH (Modify) request.

When an SIP message transmitted from the SIP server 7 is received by the SIP client 5 via the other SIP server 8, an SIP message transmitted from the SIP client 5 on the other party side to the SIP client 4 during the same session passes through the same SIP server 7. Therefore, by performing the addition of the identification information of the SIP server 7 from the first response to the INVITE message in the above-mentioned manner, the identification information of the SIP server 7 to which the first INVITE message is distributed may be included in the header of the subsequent message.

The server identification unit 24 of the distribution server 6 obtains the identification information of the SIP server 7 reassigned to the subsequent message from the SIP message added with the identification information of the SIP server 7 by the header processing unit 44 of the SIP server 7. The server identification unit 24 identifies the SIP server 7 to which the subsequent message is distributed on the basis of the obtained identification information. In this manner, the distribution server 6 may distribute the subsequent message to the SIP server 7 to which the first INVITE message is distributed.

4. Distribution Processing for Session Establishment Request

Subsequently, distribution processing for the INVITE message by the distribution server 6 will be described.

4.1. Table Management Processing

FIG. 8 is a flowchart illustrating an example of management processing on the distribution management table 26 by the table management unit 25.

In BA, the table management unit 25 determines whether or not the number of the SIP servers 7 is changed. In a case where the server number is changed (BA: YES), the processing advances to BB. In a case where the server number is not changed (BA: NO), the processing returns to BA.

In BB, the table management unit 25 stores the server number before the change in the memory 12.

In BC, the table management unit 25 creates the distribution management table 26.

In BD, the table management unit 25 activates a first monitor timer that monitors an elapse of the entry period T1.

In BE, the table management unit 25 determines whether or not the entry period T1 elapses. In a case where the entry period T1 elapses (BE: YES), the table management unit 25 stops registration of an entry to the distribution management table 26, and the processing advances to BF. In a case where the entry period T1 does not elapse (BE: NO), the processing returns to BE.

In BF, the table management unit 25 activates a second monitor timer that monitors an elapse of the retention period T2.

In BG, the table management unit 25 determines whether or not the retention period T2 elapses. In a case where the retention period T2 elapses (BG: YES), the processing advances to BI. In a case where the retention period T2 does not elapse (BG: NO), the processing advances to BH.

In BH, the table management unit 25 determines whether or not any entry exists in the distribution management table 26. In a case where any entry exists in the distribution management table 26 (BH: YES), the processing returns to BG. In a case where no entry exists in the distribution management table 26 (BH: NO), the processing advances to BI.

In BI, the table management unit 25 deletes the distribution management table 26.

4.2. Processing upon Reception of INVITE Message

Next, processing by the distribution server 6 upon reception of the INVITE message will be described. FIG. 9 is a flowchart illustrating an example of the processing upon reception of the INVITE message.

In CA, the table management unit 25 determines whether or not the distribution management table 26 exists. In a case where the distribution management table 26 exists (CA: YES), the processing advances to CB. In a case where the distribution management table 26 does not exist (CA: NO), the processing advances to CI.

In CB, the table management unit 25 determines whether or not an entry including the Call-ID of the INVITE message exists in the distribution management table 26. In a case where the entry exists in the distribution management table 26 (CB: YES), the processing advances to CC. In a case where the entry does not exist in the distribution management table 26 (CB: NO), the processing advances to CD.

In CC, the table management unit 25 obtains the identifier of the SIP server 7 as the transmission destination of the INVITE message from the entry including the Call-ID of the INVITE message in the distribution management table 26. The server identification unit 24 transmits the INVITE message to the SIP server 7 of the obtained identifier. After that, the processing returns to CA.

In CD, the table management unit 25 determines whether or not the entry period T1 elapses. In a case where the entry period T1 elapses (CD: YES), the processing advances to CI. In a case where the entry period T1 does not elapse (CD: NO), the processing advances to CE.

In CE, the hashing operation unit 23 calculates a hash value on the basis of the number of the SIP servers 7 before the change in the server number and the Call-ID of the received INVITE message.

In CF, the server identification unit 24 identifies the SIP server 7 to which the INVITE message is distributed by using the identifier of the SIP server 7, which is determined on the basis of the hash value calculated in CE.

In CG, the server identification unit 24 transmits the INVITE message to the identified SIP server 7.

In CH, the table management unit 25 registers, in the distribution management table 26, an entry including the Call-ID of the INVITE message and the identifier of the SIP server 7, which is determined on the basis of the hash value calculated in CE. After that, the processing ends. It is noted that CH may be executed in an order prior to any one of CF and CG.

In CI, the hashing operation unit 23 calculates a hash value on the basis of the number of the SIP servers 7 after the change in the server number and the Call-ID of the received INVITE message.

In CJ, the server identification unit 24 identifies the SIP server 7 to which the INVITE message is distributed by using the identifier of the SIP server 7, which is determined on the basis of the hash value calculated in CI.

In CK, the server identification unit 24 transmits the INVITE message to the identified SIP server 7. After that, the processing ends.

4.3. Processing upon Reception of ACK Message

Next, processing by the distribution server 6 upon reception of the ACK message will be described. FIG. 10 is a flowchart illustrating an example of the processing upon reception of the ACK message.

In DA, the table management unit 25 determines whether or not the distribution management table 26 exists. In a case where the distribution management table 26 exists (DA: YES), the processing advances to DB. In a case where the distribution management table 26 does not exist (DA: NO), the processing advances to DD.

In DB, the table management unit 25 determines whether or not an entry including the Call-ID of the ACK message exists in the distribution management table 26. In a case where the entry exists in the distribution management table 26 (DB: YES), the processing advances to DC. In a case where the entry does not exist in the distribution management table 26 (DB: NO), the processing advances to DD.

In DC, the table management unit 25 deletes the entry including the Call-ID of the ACK message from the distribution management table 26. After that, the processing advances to DD.

In DD, the server identification unit 24 performs distribution processing for the ACK message through distribution processing for the subsequent message which will be described later in “5.2. Processing in Distribution Server Apparatus”.

4.4.1. First Example of Processing Performed when Server Number is Changed

Subsequently, distribution processing for the INVITE message at a time when the server number is changed will be described with reference to FIGS. 11, 12A-12C, and 13-15. In any of the following examples, a case is assumed in which the number of the SIP servers 7 is changed from 3 to 4. Also, for sake of simplicity, the hash value H for identifying the SIP server 7 to which the SIP message is distributed is determined by “H=the Call-ID mod the server number”. In addition, identifiers of the SIP server 7-0 to 7-3 are respectively “00”, “01”, “02”, and “03” and respectively correspond to hash values “0”, “1”, “2”, and “3”.

FIG. 11 is a sequence diagram illustrating a first example of the processing performed when the server number is changed.

In EA, the SIP client 4-0 transmits, to the distribution server 6, a first INVITE message in which the value of the Call-ID is “8”. At this time point, since the number of the SIP servers 7 is 3, the hash value becomes (H=8 mod 3=2).

In EB, the distribution server 6 transmits the INVITE message to the SIP server 7-2 corresponding to the hash value 2 calculated in EA.

In EC, the number of the SIP servers 7 to which the distribution server 6 distributes the SIP messages is changed from 3 to 4.

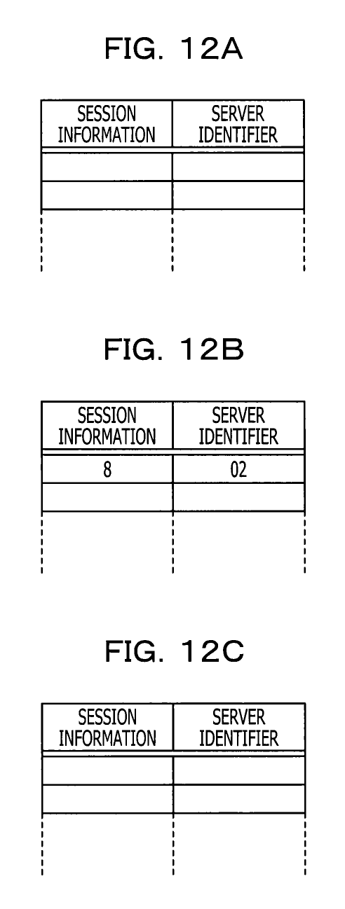

In ED, the distribution server 6 that has detected the change in the server number creates the distribution management table 26. Contents of the distribution management table 26 at this time point are illustrated in FIG. 12A. At this time point, the entry does not yet exist in the distribution management table 26. Also, the distribution server 6 activates the first monitor timer.

In EE, the SIP client 4-0 transmits a retransmitted INVITE message with respect to the first INVITE message to the distribution server 6. The value of the Call-ID of the retransmitted INVITE message is the same as the value “8” of the Call-ID of the first INVITE message. The distribution server 6 determines whether or not an entry including the Call-ID “8” of the received retransmitted INVITE message exists in the distribution management table 26.

At this time point, since the entry including the Call-ID “8” does not exist in the distribution management table 26 and also the time is within the entry period T1, the distribution server 6 registers the entry including the Call-ID “8” in the distribution management table 26. At that time, the distribution server 6 determines the identifier of the SIP server 7, which is to be set as the information element “server identifier”, by using the hash value calculated based on the number of the SIP servers 7 before the change in the server number. The identifier of the SIP server 7 to be registered is the same as the identifier “02” of the SIP server 7-2 to which the first INVITE message is distributed. Contents of the distribution management table 26 at this time point are illustrated in FIG. 12B. In the distribution management table 26, an entry including the session information “8” and the server identifier “02” is registered.

In EF, the distribution server 6 transmits the retransmitted INVITE message to the SIP server 7-2 having the registered identifier “02”. For this reason, the retransmitted INVITE message is distributed to the SIP server 7-2 to which the first INVITE message is distributed.

In EG, the entry period T1 expires, and the distribution server 6 activates the second monitor timer. After the expiration of the entry period T1, the distribution server 6 does not perform registration of a new entry in the distribution management table 26.

In EH, the SIP client 4-0 transmits, to the distribution server 6, a retransmitted INVITE message with respect to the first INVITE message. The value of the Call-ID of the retransmitted INVITE message is the same as the value “8” of the Call-ID of the first INVITE message. The distribution server 6 determines whether or not an entry including the Call-ID “8” of the retransmitted INVITE message exists in the distribution management table 26.

At this time point, since the entry including the Call-ID “8” exists in the distribution management table 26, the distribution server 6 obtains the identifier “02” of the SIP server 7-2 to which the retransmitted INVITE message is distributed.

In EI, the distribution server 6 transmits the retransmitted INVITE message to the SIP server 7-2 having the obtained identifier “02”. For this reason, the retransmitted INVITE message is distributed to the SIP server 7-2 to which the first INVITE message is distributed.

In EJ, the SIP client 4-0 transmits, to the distribution server 6, an ACK message including the same session information as that included in the first INVITE message. The value of the Call-ID of the ACK message is “8” similarly as in the first INVITE message. The distribution server 6 determines whether or not an entry including the Call-ID “8” of the received ACK message exists in the distribution management table 26. At this time point, since the entry including the Call-ID “8” exists in the distribution management table 26, the distribution server 6 deletes the entry including the Call-ID “8”. Contents of the distribution management table 26 at this time point are illustrated in FIG. 12C. At this time point, the distribution management table 26 is empty.

In EK, the distribution server 6 distributes the ACK message as a subsequent message to the SIP server 7-2 through the distribution processing for the subsequent message described above in “3.2. Exemplary Functional Configuration” of “3. SIP Server Apparatus”.

In EL, since the distribution server 6 detects that the distribution management table 26 is empty, the distribution server 6 deletes the distribution management table 26.

In EM, the retention period T2 expires. After that, since the distribution management table 26 does not exist, the distribution server 6 determines the SIP server 7 to which the received INVITE message is distributed by using a hash value calculated based on the server number “4” after the change.

4.4.2. Second Example of Processing Performed when Server Number is Changed

FIG. 13 is a sequence diagram illustrating a second example of the processing performed when the server number is changed. In this case, the first INVITE message is generated in the entry period T1 after the change in the server number.

In FA, the number of the SIP servers 7 to which the distribution server 6 distributes the SIP messages is changed from 3 to 4.

In FB, the distribution server 6 that has detected the change in the server number creates the distribution management table 26. The distribution server 6 activates the first monitor timer.

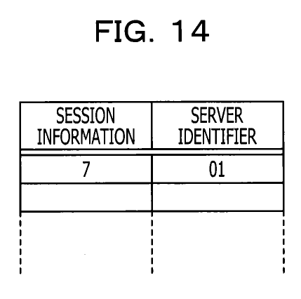

In FC, the SIP client 4-1 transmits, to the distribution server 6, a first INVITE message in which the value of the Call-ID is “7”. At this time point, an entry including the Call-ID “7” does not exist in the distribution management table 26, and also the time is within the entry period T1. The distribution server 6 registers the entry including the Call-ID “7” in the distribution management table 26 without distinguishing the first INVITE message from a retransmitted INVITE message. At that time, the distribution server 6 determines the identifier of the SIP server 7, which is to be set as the information element “server identifier”, by using the hash value calculated based on the number “3” of the SIP servers 7 before the change in the server number. The hash value becomes (H=7 mod 3=1). The identifier of the SIP server 7 to be registered is “01” corresponding to the hash value “1”. The distribution server 6 registers an entry including the Call-ID “7” and the server identifier “01” in the distribution management table 26. Contents of the distribution management table 26 at this time point are illustrated in FIG. 14.

In FD, the distribution server 6 transmits the first INVITE message to the SIP server 7-1 having the registered identifier “01”.

In FE, the entry period T1 expires, and the distribution server 6 activates the second monitor timer. After the expiration of the entry period T1, the distribution server 6 does not perform registration of a new entry in the distribution management table 26.

In FF, the SIP client 4-1 transmits, to the distribution server 6, a retransmitted INVITE message with respect to the first INVITE message. The value of the Call-ID of the retransmitted INVITE message is the same as the value “7” of the Call-ID of the first INVITE message. The distribution server 6 determines whether or not an entry including the Call-ID “7” of the retransmitted INVITE message exists in the distribution management table 26.

At this time point, since the entry including the Call-ID “7” exists in the distribution management table 26, the distribution server 6 obtains the identifier “01” of the SIP server 7-1 to which the retransmitted INVITE message is distributed.

In FG, the distribution server 6 transmits the retransmitted INVITE message to the SIP server 7-1 having the obtained identifier “01”. For this reason, the retransmitted INVITE message is distributed to the SIP server 7-1 to which the first INVITE message is distributed.

In FH, the distribution server 6 detects that the retention period T2 has expired and deletes the distribution management table 26. After that, since the distribution management table 26 does not exist, the distribution server 6 determines the SIP server 7 to which the received INVITE message is distributed by using a hash value calculated based on the server number “4” after the change.

4.4.3. Third Example of Processing Performed when Server Number is Changed

FIG. 15 is a sequence diagram illustrating a third example of the processing performed when the server number is changed. In this case, the first INVITE message is generated in the retention period T2.

In GA, the number of the SIP servers 7 to which the distribution server 6 distributes the SIP messages is changed from 3 to 4.

In GB, the distribution server 6 that has detected the change in the server number creates the distribution management table 26. The distribution server 6 activates the first monitor timer.

In GC, the entry period T1 expires, and the distribution server 6 activates the second monitor timer. After the expiration of the entry period T1, the distribution server 6 does not perform registration of a new entry in the distribution management table 26.

In GD, the SIP client 4-2 transmits, to the distribution server 6, a first INVITE message in which the value of the Call-ID is “9”. At this time point, an entry including the Call-ID “9” does not exist in the distribution management table 26, and the entry period T1 has expired. The distribution server 6 determines the SIP server 7 to which the INVITE message is distributed by using the hash value calculated based on the number “4” of the SIP servers 7 after the change in the server number. The hash value becomes (H=9 mod 4=1). The identifier of the SIP server 7 to which the INVITE message is distributed is “01” corresponding to the hash value “1”.

In GE, the distribution server 6 transmits the first INVITE message to the SIP server 7-1 having the identifier “01”.

In GF, the distribution server 6 deletes the empty distribution management table 26.

In GG, the retention period T2 expires. After that, since the distribution management table 26 does not exist, the distribution server 6 determines the SIP server 7 to which the received INVITE message is distributed by using a hash value calculated based on the server number “4” after the change.

5. Distribution Processing for Subsequent Message

Subsequently, distribution processing for the subsequent message by the distribution server 6 and the SIP server 7 will be described.

5.1. Processing in SIP Server Apparatus

As described above, when transmitting, to the distribution server 6, the SIP message which is to be transferred to the SIP client 4, the SIP server 7 adds the identification information of the SIP server 7 to the tag among the headers of this message, which is to be reassigned to a message to be transmitted from the SIP client 4.

According to the present embodiment, when transmitting an SIP request to the distribution server 6, the SIP server 7 may add the identification information of the SIP server 7 to the tag in the From header field of the SIP message. In addition, when transmitting an SIP response to the distribution server 6, the SIP server 7 may add the identification information of the SIP server 7 to the tag in the To header field of the SIP message.

An example will be illustrated below in which the SIP server 7-0 adds the identifier “00” of the SIP server 7-0 to the tag in the To header field of the 180 Ringing message which is an example of a response to the INVITE message.

SIP/2.0 180 Ringing

Via: SIP/2.0/UDP example.com:5060;branch=z9hG4bK74bf9; received=192.0.2.101

From: Alice <sip:alice@example.com>; tag=9fxced76sl

To: Bob <sip:bob@example.com>;tag=8321234300

Call-ID: 6

CSeq: 1 INVITE

Contact: <sip:bob@example.com;transport=udp>

Content-Length: 0

According to the above-mentioned example, the identifier “00” of the SIP server 7-0 is added as the last two digits of the tag “tag=8321234300” in the To header field.

Upon receiving an SIP request, the SIP client 4 transmits a subsequent message after the SIP request while reassigning the tag in the From header field of the SIP request to the From header field of the subsequent message in the same session as the SIP request. In addition, upon receiving an SIP response, the SIP client 4 transmits a subsequent message in the same session as the SIP response while reassigning the tag in the To header field of the SIP response to the To header field of the subsequent message.

An SIP message transmitted from an SIP client on the other party side which is connected in the session with the SIP client 4 passes through the SIP server 7 through which the SIP message transmitted from the SIP client 4 passes. Therefore, by performing the addition of the identification information of the SIP server 7 from the first response to the INVITE message, the identification information of the SIP server 7 to which the first INVITE message is distributed may be included in the header of the subsequent message.

An example will be illustrated below in which the SIP client 4 adds the identifier “00” of the SIP server 7-0 to the tag in the To header field of a BYE message which is an example of the subsequent message.

BYE sip:alice@example.com SIP/2.0

Via: SIP/2.0/UDP example.com:5060;branch=z9hG4bKnashds7

Max-Forwards: 70

From: Alice <sip:alice@example.com>; tag=9fxced76sl

To: Bob <sip:bob@example.com>; tag=8321234300

Call-ID: 6

CSeq: 1 BYE

Content-Length: 0

According to the above-mentioned example, “tag=8321234300”, in which the identifier “00” of the SIP server 7-0 is added to the last two digits, is reassigned by the SIP server 7-0, as the tag in the To header field.

5.2. Processing in Distribution Server Apparatus

As described above, in a case where the subsequent message transmitted from the SIP client 4 to the distribution server 6 is an SIP request, the identification information of the SIP server 7 to which the first INVITE message is distributed is added to the tag in the To header field of the SIP request. Similarly, in a case where the subsequent message transmitted from the SIP client 4 to the distribution server 6 is an SIP response, the identification information of the SIP server 7 to which the first INVITE message is distributed is added to the tag in the From header field of the SIP response. The server identification unit 24 of the distribution server 6 determines the SIP server 7 to which the subsequent message is distributed, in accordance with the identification information of the SIP server 7, which is added to each tag.

FIG. 16 is a flowchart illustrating an example of the distribution processing for the subsequent message.

In HA, the server identification unit 24 determines a direction of the received subsequent message. That is, the server identification unit 24 determines whether the subsequent message is a message addressed to the SIP server 7 or the subsequent message is a message received from the SIP server 7. In a case where the subsequent message is the message addressed to the SIP server 7 (HA: YES), the processing advances to HB. In a case where the subsequent message is not the message addressed to the SIP server 7 (HA: NO), the processing advances to HF.

In HB, the server identification unit 24 determines a type of the received message. In a case where the received message is a request (HB: YES), the processing advances to HC. In a case where the received message is a response (HB: NO), the processing advances to HD.

In HC, the server identification unit 24 obtains the identification information of the SIP server 7 to which the received message is distributed from the tag in the To header field of the received message. After that, the processing advances to HE.

In HD, the server identification unit 24 obtains the identification information of the SIP server 7 to which the received message is distributed from the tag in the From header field of the received message. After that, the processing advances to HE.

In HE, the server identification unit 24 distributes the received message to the SIP server 7 identified on the basis of the obtained identification information. After that, the processing ends.

In HF, the SIP message transmission unit 21 transmits the received message to the SIP client 4. After that, the processing ends.

Subsequently, with reference to FIG. 17, an example of processing performed upon reception of a subsequent message will be described.

In IA, the SIP client 4-2 transmits, to the distribution server 6, an INVITE message in which the value of the Call-ID is “6”. At this time point, since the number of the SIP servers 7 is 3, the hash value becomes (H=6 mod 3=0).

In IB, the distribution server 6 transmits the INVITE message to the SIP server 7-0 corresponding to the hash value 0 calculated in IA.

In IC, the SIP server 7-0 adds the identifier “00” of the SIP server 7-0 to the tag in the To header field of a 180 Ringing message which is a response message to the INVITE message and then transmits the 180 Ringing message to the distribution server 6.

In ID, the distribution server 6 transmits the 180 Ringing message received from the SIP server 7 to the SIP client 4-2.

In IE, the SIP client 4-2 transmits a BYE message in which the value of the Call-ID is “6” to the distribution server 6. At that time, the SIP client 4-2 reassigns the identifier “00” of the SIP server 7-0 added to the message by the SIP server 7-0 to the tag in the To header field of the BYE message.

In IF, the distribution server 6 transmits the BYE message to the SIP server 7-0 corresponding to the identifier “00” set in the To header field of the received BYE message.

6. Effects

Effects of the embodiments will be described below.

The distribution server 6 determines the SIP server 7 to which the subsequent message is distributed on the basis of the identifier of the SIP server 7 described in the tag in the header of the received subsequent message. For this reason, the distribution server 6 may transfer, by referencing the tag, the subsequent message in the same session as the INVITE message to the SIP server 7 to which the INVITE message is distributed, without retaining the session information or the distribution management table.

Since the distribution server 6 may identify, without performing the hashing operation, the SIP server 7 to which the subsequent message is distributed, the load on the distribution server 6 is reduced.

Even in a case where the number of the SIP servers 7 is changed, the distribution server 6 may distribute the retransmitted INVITE message to the same SIP server 7 as the first INVITE message without retaining the session information or the distribution management table.

Since the distribution server 6 does not retain the session information or the distribution management table in the above-mentioned manner, a diminishment in the processing performance, which is caused by exclusive processing or the like at the time of a data reference and update processing on a memory area and a memory access, is reduced. In addition, even when the distribution server 6 is set to be redundant, synchronization processing on the session information and the distribution management table is not performed, and therefore a diminishment in the processing performance caused by the above-mentioned synchronization processing is reduced.

It is noted that the distribution server 6 temporarily determines a distribution destination of the SIP message by referring to the distribution management table 26, but the reference on the distribution management table 26 is limited in a predetermined period of time after the change in the number of the SIP servers 7. For this reason, a period of time in which the exclusive processing at the time of the data reference and the update processing on the memory area and the memory access or the synchronization processing on the memory is limited, and therefore the diminishment in the processing performance of the distribution server 6 is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A message distribution server comprising:
a processor configured to
receive a first SIP (Session Initiation Protocol) message from an SIP client,
obtain an identifier of an SIP server from a header of the first SIP message,
identify an SIP server corresponding to the obtained identifier from among a plurality of SIP servers each configured to control a session for the SIP client, and
distribute the first SIP message to the identified SIP server.

2. The message distribution server according to claim 1, further comprising:
a storage apparatus,
wherein
the processor is further configured to
detect a change in a server number, the server number indicating number of the plurality of SIP servers,
identify, based on the server number before the change, an SIP server to which a second SIP message received after the change from the SIP client is distributed,
store, in the storage apparatus, server specification information regarding the session for the SIP client, the server specification information specifying the SIP server identified based on the server number before the change,
distribute, based on the stored server specification information, the second SIP message during a predetermined period of time after the change, and
delete the server specification information from the storage apparatus after the predetermined period of time.

3. The message distribution server according to claim 1, wherein
the identifier has been reassigned by the SIP client from a header of a third SIP message received by the SIP client to the header of the first SIP message.

4. The message distribution server according to claim 1, wherein
the first SIP message is a request message, and
the processor is configured to obtain the identifier from an action addressee specification header field of the first SIP message.

5. The message distribution server according to claim 1, wherein
the first SIP message is a response message, and
the processor is configured to obtain the identifier from a generation origin specification header field of the first SIP message.

6. The message distribution server according to claim 2, wherein
the processor further configured to store, upon receiving a session establishment request message after the change, server specification information regarding a session for the session establishment request message in the storage apparatus.

7. The message distribution server according to claim 2, wherein
the processor is further configured to delete, upon receiving an acknowledge response message as a final response to a session establishment request message, the server specification information regarding a session for the acknowledge response message from the storage apparatus.

8. An SIP (Session Initiation Protocol) server that controls a session for an SIP client, the SIP server comprising:
a processor configured to
add an identifier of the SIP server to one header among headers of a first SIP message transmitted from the SIP server to the SIP client, the one header being reassigned to a header of a second SIP message transmitted from the SIP client.

9. A computer-readable recording medium storing a program that causes a computer to execute a procedure, the procedure comprising:
receiving an SIP (Session Initiation Protocol) message from an SIP client;
obtaining an identifier of an SIP server from a header of the received SIP message;
identifying an SIP server corresponding to the obtained identifier from among a plurality of SIP servers each configured to control a session for the SIP client; and
distributing the received SIP message to the identified SIP server.

10. A message distribution method comprising:
receiving, by a computer, an SIP (Session Initiation Protocol) message from an SIP client;
obtaining an identifier of an SIP server from a header of the received SIP message;
identifying an SIP server corresponding to the obtained identifier from among a plurality of SIP servers each configured to control a session for the SIP client; and
distributing the received SIP message to the identified SIP server.
